(19) United States
(12) Patent Application Publication
(10) Pub. No.: US 2019/0332977 A1
(43) Pub. Date: Oct. 31, 2019

(54) DEMAND FORECAST DEVICE

(71) Applicant: NTT DOCOMO, INC., Chiyoda-ku (JP)

(72) Inventors: Shin ISHIGURO, Chiyoda-ku (JP); Haruka KIKUCHI, Chiyoda-ku (JP); Yusuke FUKAZAWA, Chiyoda-ku (JP); Ken ENOKIZONO, Chiyoda-ku (JP)

(73) Assignee: NTT DOCOMO, INC., Chiyoda-ku (JP)

(21) Appl. No.: 16/347,437

(22) PCT Filed: May 10, 2018
(86) PCT No.: PCT/JP2018/018148

§ 371 Date: May 3, 2019

(30) Foreign Application Priority Data
May 11, 2017 (JP) 2017-094966

(51) Int. Cl. G06Q 10/04; G06Q 50/30; G06N 3/08; G08G 1/00

(52) U.S. Cl. CPC G06Q 10/04; G08G 1/205; G06N 3/08; G06Q 50/30

(57) ABSTRACT

A server 10 according to one embodiment comprises: a first statistic acquisition unit 13 acquiring a first statistic representing a feature associated with a past period related to a forecast target area; an area extraction unit 14 extracting at least one related area that is different in size from the forecast target area and surrounds the forecast target area; a second statistic acquisition unit 15 acquiring a second statistic representing a feature of the related area; and a demand forecast unit 16 inputting the first statistic and the second statistic to a forecasting model prepared in advance, thereby acquiring a forecasted demand value in the forecast target area.

### TECHNICAL FIELD

One aspect of the present invention relates to a demand forecast device.

### BACKGROUND ART

Patent Literature 1 describes a demand forecast system for forecasting a taxi demand (the number of times of pickup) in a certain mesh (area). The above-described system first generates a first regression equation for each of a plurality of meshes based on the actual demand value related to each mesh, and calculates an intermediate forecasted demand value (the forecasted number of times of pickup for each mesh) using the first regression equation. Subsequently, the system selects one of the plurality of meshes as a forecast target area, extracts a mesh correlated with the forecast target area as a correlated area, generates a second regression equation based on the actual demand value of the correlated area, and calculates the final forecasted demand value related to the forecast target area by using the second regression equation.

### CITATION LIST

### Patent Literature

Patent Literature 1 Japanese Unexamined Patent Publication No. 2012-050241

### SUMMARY OF INVENTION

### Technical Problem

The technique described in Patent Literature 1 generates a specific forecasting model (first regression equation) for each of a plurality of areas and generates a specific forecasting model (second regression equation) for each forecast target area. When a forecasting model is individually generated for each area in this way, processing may become more complicated as the number of areas to be forecasted increases.

If a common forecasting model can be used for a plurality of forecast target areas, the above-mentioned problem can be avoided. Even in the case where a common forecasting model is used, forecast accuracy can be improved by demand forecast based on statistical data related to areas other than the forecast target area as described in Patent Literature 1. However, when this statistical data is statistical data related to an area having a simple positional relationship with the forecast target area (for example, a mesh located in a specific direction (for example, upper right) with respect to the forecast target mesh), the following problem may arise. In particular, the forecast accuracy varies among areas: the demand can be accurately forecasted for the area correlated with the upper right mesh, while the demand cannot be accurately forecasted for the areas not correlated with the upper right mesh.

To solve this problem, an object of one aspect of the present invention is to provide a demand forecast device that can suppress variations in forecast accuracy among a plurality of areas in the case where a forecasting model common to the areas is used.

### Solution to Problem

A demand forecast device according to one aspect of the present invention comprises: a first statistic acquisition unit acquiring a first statistic representing a feature associated with a past period related to a forecast target area serving as a target for forecast of a demand of a predetermined service; an area extraction unit extracting at least one related area that is different in size from the forecast target area and surrounds the forecast target area; a second statistic acquisition unit acquiring a second statistic representing a feature of the related area; and a demand forecast unit inputting the first statistic and the second statistic to a forecasting model prepared in advance, thereby acquiring a forecasted demand value in the forecast target area.

The demand forecast device according to one aspect of the present invention calculates the forecasted demand value in the forecast target area, based on not only the statistic (the first statistic) related to the forecast target area but also the statistic (the second statistic) related to the related area that is different in size from the forecast target area and surrounds the forecast target area. The second statistic related to such a related area can possibly be data useful for improving the accuracy of the demand forecast in the forecast target area, regardless of which area is selected as the forecast target area. Accordingly, the demand forecast device can suppress variations in forecast accuracy among a plurality of areas in the case where a forecasting model common to the areas is used.

### Advantageous Effects of Invention

One aspect of the present invention can provide a demand forecast device that can suppress variations in forecast accuracy among a plurality of areas in the case where a forecasting model common to the areas is used.

### BRIEF DESCRIPTION OF DRAWINGS

FIG. 1 is a diagram showing the functional configuration of a server including a demand forecast device according to one embodiment.

FIG. 2 is a diagram showing one example of statistical data for each mesh (area).

FIG. 3 is a diagram showing examples of the first mesh and the second mesh.

FIG. 4 is a diagram showing examples of the first mesh and the second mesh.

FIG. 5 is a diagram showing examples of the first mesh and the second mesh.

FIG. 6 is a diagram for explaining a time difference determined by correlation analysis.

FIG. 7 is a flow chart showing the procedure of processing in which the server shown in FIG. 1 generates a forecasting model.

FIG. 8 is a flow chart showing the procedure of processing in which the server shown in FIG. 1 acquires the forecasted demand value in a forecast target area.

FIG. 9 is a diagram showing the hardware configuration of the server shown in FIG. 1.

### DESCRIPTION OF EMBODIMENTS

One embodiment of the present invention will now be described in detail with reference to the accompanying drawings. It should be noted that in the description of the drawings, the same or corresponding components are denoted by the same reference numeral, and overlapping description will be omitted.

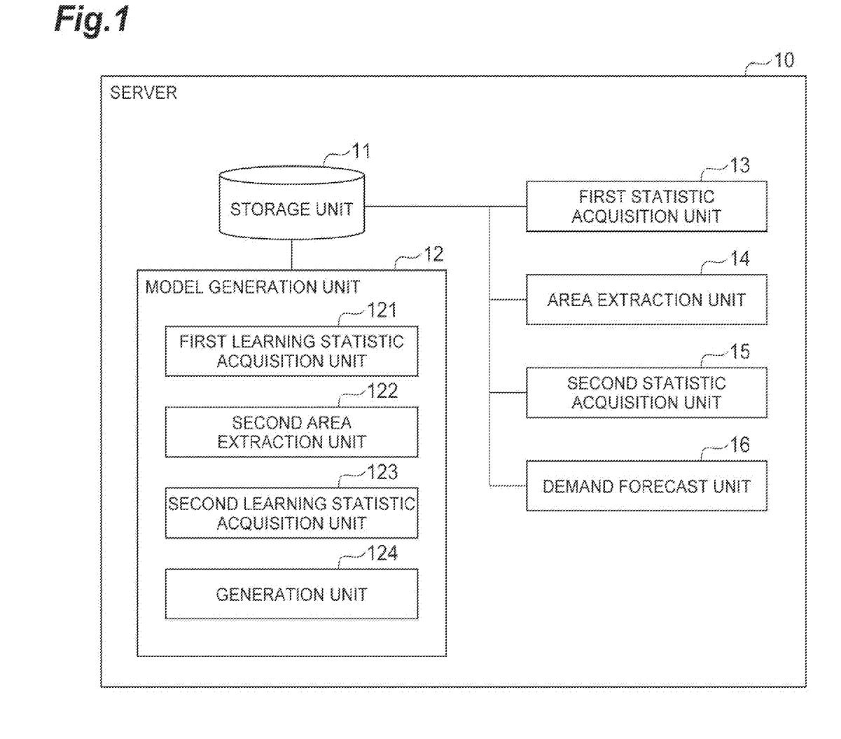

FIG. 1 is a diagram showing the functional configuration of a server 10 including a demand forecast device according to one embodiment. The server 10 is a computer system that forecasts the demand of a forecast target area selected as a target of the forecast of the demand of a predetermined service. In this embodiment, the server 10 forecasts a taxi demand (the number of taxi passengers) in the forecast target area. To be specific, as an example, the server 10 calculates the predicted value of a taxi demand occurring in the forecast target area in 30 minutes from the present time (the execution of the demand forecast).

As shown in FIG. 1, the server 10 includes a storage unit 11, a model generation unit 12, a first statistic acquisition unit 13, an area extraction unit 14, a second statistic acquisition unit 15, and a demand forecast unit 16.

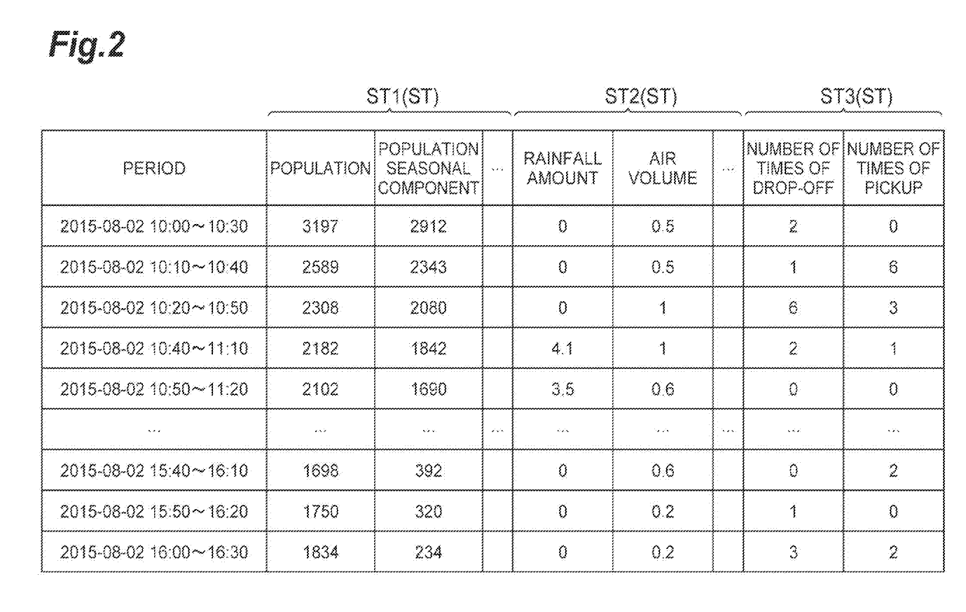

The storage unit 11 stores various kinds of information required for processing in the server 10. For example, the storage unit 11 stores a statistical data management table (see FIG. 2) that stores various statistical data for each mesh. The mesh is a preset geographical section, for example, a square region in a diameter of 500 m. Various information stored in the storage unit 11 is accessible from the model generation unit 12, the first statistic acquisition unit 13, the area extraction unit 14, the second statistic acquisition unit 15, and the demand forecast unit 16.

The model generation unit 12 generates a forecasting model for forecasting the taxi demand in a forecast target area. The model generation unit 12 includes a first learning statistic acquisition unit 121, a second area extraction unit 122, a second learning statistic acquisition unit 123, and a generation unit 124.

For at least one first area, the first learning statistic acquisition unit 121 acquires a first learning statistic that represents a feature of a first area associated with a predetermined target period, and the actual demand value of the first area associated with a period after the target period. The first learning statistic corresponds to an explanatory variable of the forecasting model. The actual demand value of the first area corresponds to the target variable of the forecasting model. For example, the first learning statistic acquisition unit 121 acquires the first learning statistic and the actual demand value by referring to the statistical data management table (FIG. 2) that stores various statistical data for each mesh. The first area is, for example, a region corresponding to one mesh.

FIG. 2 shows an example of a statistical data management table storing various statistical data for a certain mesh. In this example, statistical data ST stored in the statistical data management table includes various statistical information for each of unit periods (here, 30 minutes) having a counting start time shifted every 10 minutes. In this embodiment, statistical data ST includes population data ST1, weather data ST2, and taxi data ST3.

Population data ST1 is statistical information related to the staying population (for example, the average population in the unit period) in the mesh. Population data ST1 includes information such as the entire population (“population” column) and a population component attributable to seasonality (“population seasonal component” column). The factor of population fluctuations can be decomposed into, for example, a trend fluctuation component (Trend), a cycle fluctuation component (Cycle), a seasonal fluctuation component (Seasonal), and irregular fluctuation component (Irregular, Noise). Such factor decomposition can be executed by, for example, a known algorithm. A trend fluctuation component is a value that periodically fluctuates in a relatively long cycle. A cycle fluctuation component is a value that periodically fluctuates in a relatively short cycle. A seasonal fluctuation component is a value that fluctuates depending on events such as large consecutive holidays and New Year's holidays. An irregular fluctuation component is a component that is not included in the trend fluctuation component, the cycle fluctuation component, and the seasonal fluctuation component, and is a value irregularly fluctuating. A population seasonal component included in population data ST1 corresponds to the above-described seasonal fluctuation component. Note that the breakdown of population data ST1 is not limited to the above-mentioned example. For example, population data ST1 may include various information related to a population, such as a population by gender, a population by age, and a population by location of residence. In addition, population data ST1 may include the above-described trend fluctuation component, cycle fluctuation component, and irregular fluctuation component.

Weather data ST2 is statistical information related to the weather in the mesh. Weather data ST2 includes information on a rainfall amount, and air volume. Note that the breakdown of weather data ST2 is not limited to the above-mentioned example. For example, weather data ST2 may include information on an air temperature, humidity, air volume, wind direction, air pressure, and the like.

Taxi data ST3 is statistical information related to taxi rides in the mesh. Taxi data ST3 includes information on the number of times of pickup and the number of times of drop-off. Note that the breakdown of taxi data ST3 is not limited to the above-mentioned example. For example, taxi data ST3 may include information on the number of empty taxis. The number of empty taxis (empty amount) is the number of taxis that pass through the mesh in the unit period with no passengers inside.

First, the first learning statistic acquisition unit 121 sets a first area and a target period by receiving an input from an operator, for example. The target period may be an arbitrary period (for example, six hours from 10:00 on Aug. 2, 2015 to 16:00 on the same day). Subsequently, the first learning statistic acquisition unit 121 acquires the statistical data ST related to the target period as a first learning statistic by referring to the statistical data ST of the first area.

The first learning statistic acquisition unit 121 acquires the number of times of pickup for a period after the target period (for example, 30 minutes from 16:00 on Aug. 2, 2015 to 16:30 on the same day, which is the end point of the target period) (“2” in the example of FIG. 2) as the actual demand value in the first area.

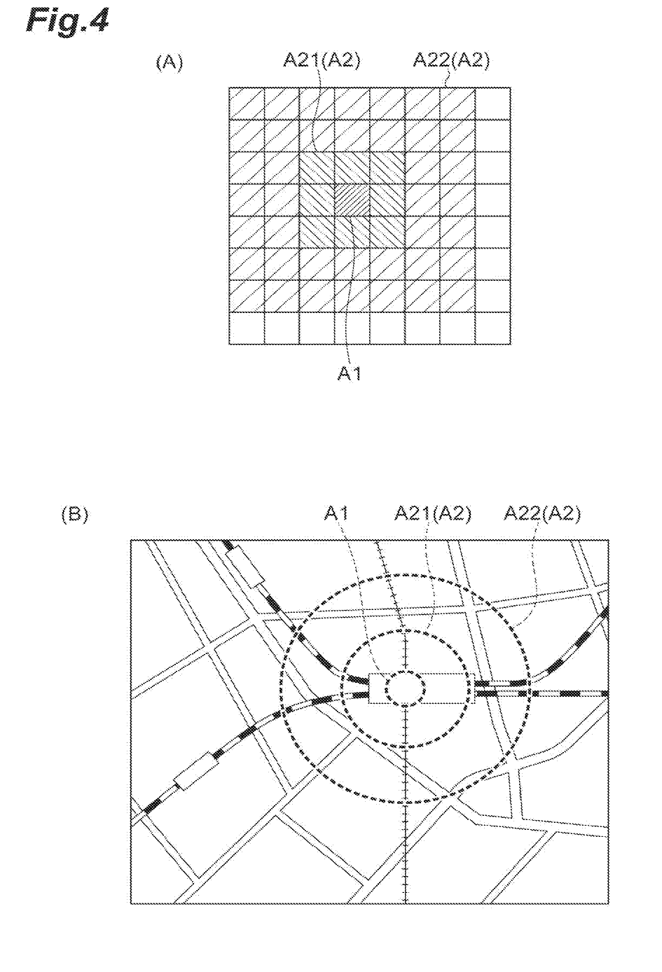

It should be noted that the first area is not necessarily a region consisting of one mesh. For example, the first area may be a circular region (see the first area A1 in a part (B) of FIG. 4 which will be described later) or the like. In this case, the first learning statistic acquisition unit 121 may acquire the statistical data ST related to a mesh included in the first area as the first learning statistic. In the case where a plurality of meshes is included in the first area, the first learning statistic acquisition unit 121 may perform a predetermined operation (for example, an operation for obtaining a sum or an average) on statistics associated with the same period and the same item for the statistical data ST related to each of the plurality of meshes. Subsequently, the first learning statistic acquisition unit 121 may acquire statistics (for example, sums and averages) obtained through the operation as first learning statistics corresponding to the respective periods and items. At this time, the first learning statistic acquisition unit 121 may specify only the mesh that is completely included in the first area, as a mesh included in the first area. Alternatively, for the mesh that is not completely included in the first area, the first learning statistic acquisition unit 121 may perform the above-mentioned calculation using a value obtained by multiplying each value of statistical data ST related to the mesh by the proportion of a mesh portion included in the first area to the area of the entire mesh (the area of the mesh portion included in the first area/the area of the entire mesh).

The second area extraction unit 122 extracts at least one second area that is different in size from the first area and surrounds the first area. Several examples of the first area and the second area will be described below. The first to third extraction examples are examples in which the second area is extracted based on the distance from the first area. The fourth extraction example is an example in which the second area is extracted based on the travel time to/from the first area.

### First Extraction Example

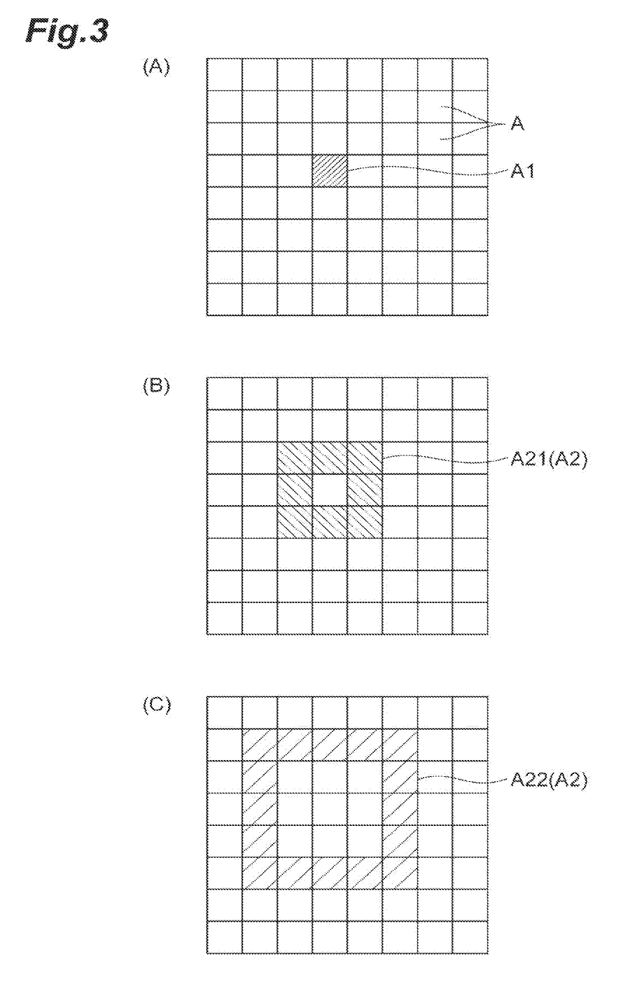

The first area may be a region corresponding to one mesh preset as a geographical section, and the second area extraction unit 122 may extract a region consisting of a plurality of meshes as a second area. A part (A) of FIG. 3 shows one first area A1 selected from a plurality of areas A (meshes). A part (B) of FIG. 3 shows one second area A21 corresponding to the first area A1, and a part (C) of FIG. 3 shows the other second area A22 corresponding to the first area A1. As shown in FIG. 3, the second area extraction unit 122 may extract an area into which meshes having the same distance from the first area A1 are collected as the second area A2. The “distance” here can be represented by the number of meshes existing between each mesh and the first area A1. The second area A21 is a quadrangular frame area consisting of eight meshes adjacent to the first area A1 (an area into which meshes having no mesh existing between each mesh and the first area A1 are collected). The second area A22 is a quadrangular frame area surrounding the second area A21 (an area into which 16 meshes having one mesh existing between each mesh and the first area A1 are collected). The number of second areas A2 to be extracted may be one, or three or more. For example, the second area extraction unit 122 may increase the number of meshes existing between the mesh of interest and the first area A1 by one by one and extract the area corresponding to each number of meshes (for example, an area consisting of 24 meshes or an area consisting of 32 meshes) as the second area A2.

### Second Extraction Example

The second area extraction unit 122 may extract the second area A2 so that the number of meshes to be collected (here, the frame width of the area formed into a frame) increases as the distance from the first area A1 (that is, the number of meshes existing between the mesh of interest and the first area A1) increases. For example, as shown in a part (A) of FIG. 4, the second area A22 (A2) (one mesh exists between the second area A22 and the first area A1) may be an area having a quadrangular frame shape with a frame width that is twice the width of one mesh. In general, an area more distanced from the first area A1 tends to have a lower correlation with the first area A1. Accordingly, in this example, the number of meshes included in the second area A2 that is less important in relation to the first area A1 is increased, so that the number of areas A2 can be reduced while considering the statistical data ST related to more meshes. As a result, the number of explanatory variables (specifically, the number of dimensions of the second learning statistic which will be described later) required for demand forecast can possibly be reduced. Reducing the number of explanatory variables in this manner leads to a reduction in the amount of calculation and the amount of memory used. In other words, processing load and usage fees related to hardware resources, such as a processor and a memory, can be reduced.

### Third Extraction Example

The first area A1 and the second area A2 are not necessarily in the form of a mesh. For example, as shown in a part (B) of FIG. 4, the first area A1 may be set as a circular area. In this case, the second area extraction unit 122 may extract, as the second area A2, an annular region having a distance from the center of the first area A1 within a predetermined range. Suppose, for example, that a circular region with a radius of 500 m is set as the first area A1. In this case, the second area extraction unit 122 may extract, as the second area A21, an annular area having a distance d from the center of the first area A1 within the range of “500 m≤d≤1000 m”. Further, the second area extraction unit 122 may extract, as the second area A22, an annular area having a distance d from that center within the range of “1000 m d 1500 m”.

### Fourth Extraction Example

The second area extraction unit 122 may extract the second area based on the travel time to/from the first area A1. Here, the “travel time to/from the first area A1” refers to, for example, a time required for reaching a representative position of the first area A1 (for example, the center of gravity) by an assumed means of transportation (for example, car, train, or walk) when the representative position is the endpoint. Alternatively, the “travel time to/from the first area A1” may refer to a time required for reaching the second area from the representative position of the first area A1 by the assumed means of transportation when the representative position of the first area A1 is the starting point.

For example, information on roads, rail lines, stations, and the like provided in the first area A1 and the second area A2 is stored in advance in the storage unit 11. Referring to these pieces of information, the second area extraction unit 122 may execute a known shortest route search algorithm or the like to calculate the shortest route (including a means of transportation) between the representative position of the first area A1 and an arbitrary position) and the time taken to move along the shortest route. With such processing, for example, an area for which the time td required for reaching the representative position of the first area A1 falls within the range of “10 minutes≤td≤20 minutes” can be extracted as the second area A21, and an area for which the time td falls within the range of “20 minutes≤td≤30 minutes” can be extracted as the second area A22.

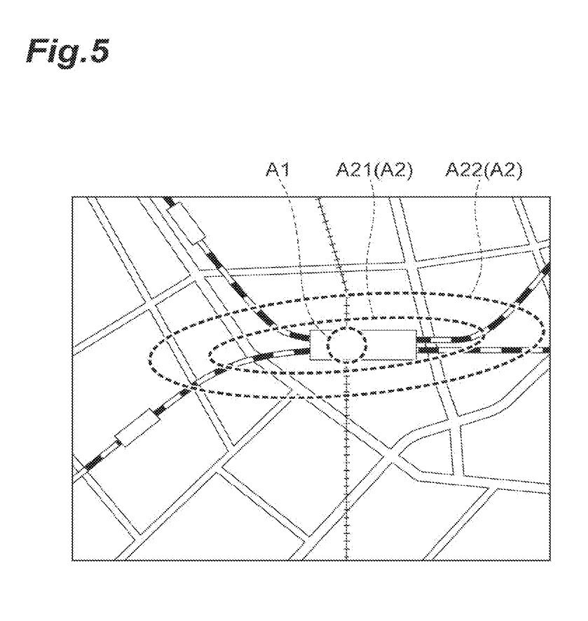

FIG. 5 is a diagram showing examples of the two second areas A21 and A22 extracted as described above. As shown in FIG. 5, the shape of the second area A2 extracted based on the travel time may change depending on the conditions of facilities (for example, the type of the roads and the legal speed provided, and the distance from the station and the service interval on the routes) in the vicinity of the first area A1.

The second learning statistic acquisition unit 123 acquires a second learning statistic representing a feature of the second area A2. Some examples of acquisition of the second learning statistic will be described below. Like the first learning statistic, the second learning statistic corresponds to an explanatory variable of a forecasting model.

### First Acquisition Example

The second learning statistic acquisition unit 123 may acquire, from the statistical data ST associated with each of the plurality of meshes included in the second area A2, the statistical data ST related to the same period as a target period set as an acquisition target period for the first learning statistic (in this embodiment, six hours from 10:00 on Aug. 2, 2015 to 16:00 on the same day).

Subsequently, the second learning statistic acquisition unit 123 acquires, as the second learning statistic for each period, one or more statistics obtained by performing a predetermined operation on statistics associated with the same period and item for the statistical data ST related to each of the plurality of meshes. The one or more statistics are, for example, values obtained by a predetermined operation, such as average values, maximum values, minimum values, median values, and variances. It should be noted that the statistical data ST related to a mesh partially included in the second area A2 is treated in the same manner as the statistical data ST related to a mesh partially included in the first area A1 in the processing for acquiring the first learning statistic.

### Second Acquisition Example

The second learning statistic acquisition unit 123 may acquire, as a second learning statistic, the statistic related to a period having a predetermined time difference from the target period set as the acquisition target period for the first learning statistic. To be specific, the second learning statistic acquisition unit 123 may determine the predetermined time difference based on the travel time between the first area A1 and the second area A2 (which is similar to the travel time described in the fourth extraction example). The time when a person staying in the second area A2 at some point in time probably takes a taxi in the first area A1 (that is, the staying population in the second area A2 at some point in time possibly affects the taxi demand in the first area A1) is probably after the above-described travel time from that point. Accordingly, more meaningful (useful) data can be used as an explanatory variable for forecasting the taxi demand in the first area A1, by shifting the acquisition target period for the statistical data ST related to the second area A2 ahead of the target period (the acquisition target period for the statistical data ST related to the first area A1) by the above-described travel time.

For example, in the case where the average value of the travel time needed to reach the representative position of the first area A1 from the second area A21 shown in a part (B) of FIG. 3 is 30 minutes, the second learning statistic acquisition unit 123 may determine 30 minutes as a predetermined time difference for the second area A21. In this case, the second learning statistic acquisition unit 123 may acquire, from the statistical data ST associated with each of the plurality of meshes included in the second area A21, the statistical data ST related to the time period shifted ahead of the target period by 30 minutes (in this embodiment, six hours from 09:30 on Aug. 2, 2015 to 15:30 on the same day). Processing carried out after acquisition of the statistical data ST associated with each of the plurality of meshes included in the second area A21 is the same as the above-described first acquisition example. When more than one second area A2 exist, the processing for the second acquisition example described above is separately executed for each second area A2.

### Third Acquisition Example

The second learning statistic acquisition unit 123 may determine the predetermined time difference based on the relationship between the actual demand value in the first area A1 and the staying population in the second area A2. The time when the staying population in the second area A2 at some point in time affects the taxi demand in the first area A1 is not necessarily after the travel time from that point in time. For this reason, the second learning statistic acquisition unit 123 determines the time difference based on the past actual values (statistical data ST) so as to maximize the correlation between the actual demand value in the first area A1 (the number of times of pickup) and the staying population in the second area A2 (in this embodiment, a difference in population from the previous time period).

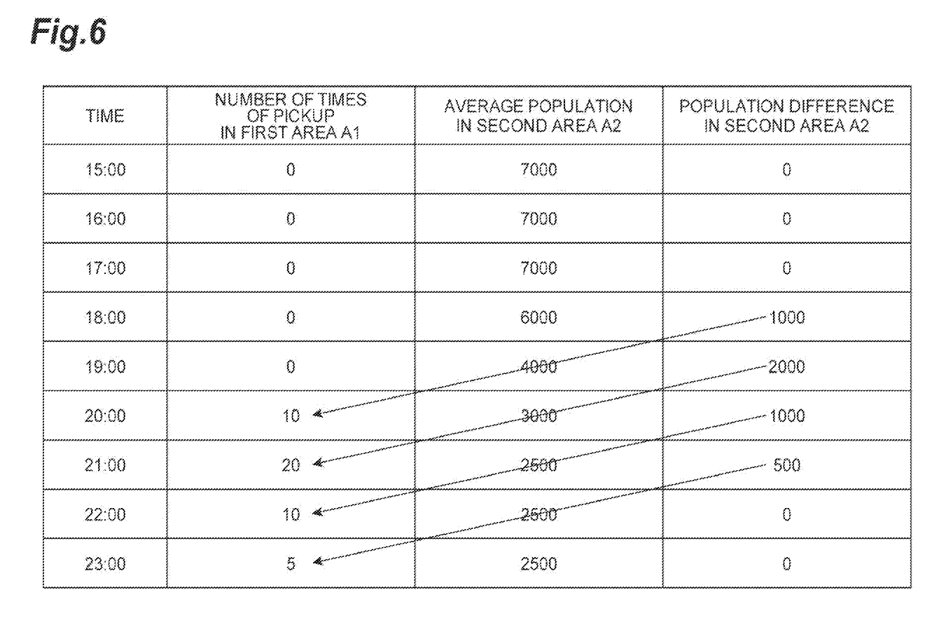

FIG. 6 shows examples of the number of times of pickup in the first area A1, staying population in the second area A2, and a difference in population from the previous time period in the second area A2 for each hourly time period. Such data is obtained from the statistical data ST related to each mesh included in the first area A1 and the statistical data ST related to each mesh included in the second area A2. The second learning statistic acquisition unit 123 determines the time difference τ with which a correlation ϕ expressed by the following expression becomes maximum, as a predetermined time difference.

$${ϕ}_{xy} [ τ ] = {\sum }_{k = 1}^{N} x [ k ] y [ k + τ ] \qquad [ Expression 1 ]$$

Here, x[k] is the number of times of pickup in the first area A1 in a time period k (for example, k=15 in the time period from 15:00 to 16:00). Further, y[k] is a population difference related to the second area A2 in the time period k. In the example shown in FIG. 6, the correlation ϕ is maximum when “τ=−2 (hours)”; therefore, the second learning statistic acquisition unit 123 determines two hours as a predetermined time difference. In other words, the second learning statistic acquisition unit 123 shifts the statistical data ST acquisition target period for the second area A2 ahead of the target period by two hours. Processing carried out after acquisition of the statistical data ST associated with each of the plurality of meshes included in the second area A21 is the same as the above-described first acquisition example. When more than one second area A2 exist, the processing for the third acquisition example described above is separately executed for each second area A2.

### Fourth Acquisition Example

Suppose, for example, that the population difference (a difference in population from the previous time period) for each time period is used as an explanatory variable, and a period in which an event (for example, a concert or a sport watching) is held in the second area A2 (for example, the start time and end time) is previously recognized. Here, suppose, in particular, that the time that has elapsed by the travel time, which is described in the second acquisition example, from the end time of the event is included in an acquisition target period in which the first learning statistic acquisition unit 121 acquires the actual demand value in the first area A1. In this case, the actual demand value in the first area A1 is probably correlated with the number of customers attracted by the event (that is, the population increment in the second area A2 at the start of the event). For this reason, in such a case, the second learning statistic acquisition unit 123 may use a time difference obtained by the addition of the event duration (for example, 2 hours) from the start to end of the event and the travel time, as a predetermined time difference.

Learning data needed for generating a forecasting model is generated by the processing in the above-described first learning statistic acquisition unit 121, second area extraction unit 122, and second learning statistic acquisition unit 123. One piece of learning data is data in which the first learning statistic and the second learning statistic are explanatory variables and the actual demand value in the first area A1 is a target variable. The first learning statistic acquisition unit 121, the second area extraction unit 122, and the second learning statistic acquisition unit 123 may execute the above-described processing for a combination of a plurality of areas and a plurality of target periods (acquisition target periods for first learning statistic). As a result, learning data of different variations can be obtained. In generation of one forecasting model, a plurality of pieces of learning data including explanatory variables acquired according to the same criterion can be used. In other words, a plurality of pieces of learning data used for generating one piece of learning data are learning data obtained using a common scheme to both the extraction of the second area A2 and the acquisition of the second learning statistic.

The generation unit 124 generates a forecasting model by executing machine learning using learning data which is data in which the first learning statistic and the second learning statistic are associated with the actual demand value in the first area A1. The generation unit 124 generates a forecasting model by using a plurality of pieces of learning data generated in the manner described above. The forecasting model is a model in which upon reception of an explanatory variable that is input data corresponding to the first learning statistic related to a forecast target area corresponding to the first area and the second learning statistic, the forecasted demand value in the forecast target area is output as a target variable. The forecasting model generated by the generation unit 124 is stored in the storage unit 11.

Although any specific method of machine learning may be used for generating a forecasting model, the generation unit 124 may generate a forecasting model by using a so-called deep learning method, for example. Such a forecasting model may include not only a conventional neural network that performs forecast processing but also a stacked auto-encoder that executes abstraction of a feature amount (explanatory variable) as preprocessing.

The processing in the model generation unit 12 described above prepares a forecasting model for forecasting the taxi demand (the number of passengers) in a forecast target area. Each functional element for actually performing demand forecast using the forecasting model will now be described.

The first statistic acquisition unit 13 acquires a first statistic representing a feature associated with a past period related to a forecast target area serving as a target for forecast of the demand of a predetermined service (in this embodiment, taxi demand). For example, the first statistic acquisition unit 13 recognizes a forecast target area (for example, one mesh) by receiving an input from an operator, for example. Then, the first statistic acquisition unit 13 acquires a first statistic needed to forecast the taxi demand for 30 minutes from the current point in time in the forecast target area.

Here, the forecast target area and the first statistic correspond to the first area and the first learning statistic handled by the model generation unit 12. Accordingly, the first statistic acquisition unit 13 cart acquire the first statistic related to the forecast target area by performing the same processing as that for acquiring the first learning statistic related to the first area (the processing in the first learning statistic acquisition unit 121). For example, in this embodiment, as the first learning statistic, the statistical data ST related to a mesh included in the first area is acquired for six hours immediately before the period corresponding to the actual demand value in the first area. In this case, like in the processing for generating a forecasting model, the first statistic acquisition unit 13 may acquire, as the first statistic, the statistical data ST related to a mesh included in the forecast target area for six hours immediately before the current point in time.

The area extraction unit 14 extracts at least one related area which is different in size from the forecast target area and surrounds the forecast target area.

Here, the related area corresponds to the second area treated by the model generation unit 12. Therefore, the area extraction unit 14 can acquire the related area associated with the forecast target area by performing the same processing as that for extracting the second area with respect to the first area (the processing in the second area extraction unit 122). For example, in the above-described first extraction example, for the first area A1 consisting of one mesh, the second area A21 consisting of 8 meshes surrounding that first area A1 and the second area A22 consisting of 16 meshes are extracted. When a forecasting model generated using the learning data obtained by such an extraction method is used, the area extraction unit 14 may extract a related area consisting of 8 meshes and a related area consisting of 16 meshes surrounding the forecast target area consisting of one mesh in the same manner as in the processing for generating the forecasting model. In other words, when any one of the above-described first to third extraction examples is adopted as a method of extracting the second area A2 for generating a forecasting model, like in the above-described processing in the second area extraction unit 122, the area extraction unit 14 extracts a related area based on the distance from the forecast target area. When the above-described fourth extraction example is adopted as a method of extracting the second area A2 for generating a forecasting model, like in the above-described processing in the second area extraction unit 122, the area extraction unit 14 extracts a related area based on the travel time to/from the forecast target area.

The second statistic acquisition unit 15 acquires the second statistic representing a feature of a related area.

Here, the second statistic corresponds to the second learning statistic handled by the model generation unit 12. Accordingly, the second statistic acquisition unit 15 can acquire the second statistic related to the related area by performing the same processing as that for acquiring the second learning statistic related to the second area (the processing in the second learning statistic acquisition unit 123).

Suppose that the second acquisition example described above is adopted for a forecasting model. In this case, the second statistic acquisition unit 15 acquires, as the second statistic, a statistic that is related to a period having a predetermined time difference from a past period (a period determined as being a target period for acquisition of the first statistic), and includes information about the staying population in the related area. To be specific, the second statistic acquisition unit 15 determines the predetermined time difference based on the travel time to/from the forecast target area. In this case, the second statistic acquisition unit 15 according to the above-described second acquisition example may perform processing in which the first learning statistic, the second learning statistic, the first area, and the second area are replaced by the first statistic, the second statistic, the forecast target area, and the related area.

Suppose that the third acquisition example described above is adopted for a forecasting model. In this case, the second statistic acquisition unit 15 determines the predetermined time difference based on the relationship between the actual demand value in the forecast target area and the staying population in the related area. In this case, the second statistic acquisition unit 15 according to the above-described third acquisition example may perform processing in which the second learning statistic, the first area, and the second area are replaced by the second statistic, the forecast target area, and the related area.

Suppose that the fourth acquisition example described above is adopted for a forecasting model. In this case, the second statistic acquisition unit 15 according to the above-described fourth acquisition example may perform processing in which the second learning statistic, the first area, and the second area are replaced by the second statistic, the forecast target area, and the related area.

The demand forecast unit 16 inputs the first statistic and the second statistic to a forecasting model prepared in advance (a forecasting model generated by the model generation unit 12), thereby acquiring the forecasted demand value in the forecast target area (the forecasted number of passengers of taxis). To be specific, the demand forecast unit 16 acquires the output result produced by the forecasting model, as the forecasted demand value in the forecast target area. The forecasted demand value obtained in this manner can be used for various purposes. For example, the demand forecast unit 16 may present the forecast result to the operator by showing the forecasted demand value on a display or the like. Further, the first statistic acquisition unit 13, the area extraction unit 14, the second statistic acquisition unit 15, and the demand forecast unit 16 may perform processing on a plurality of different forecast target areas. The forecasted demand value of each area obtained in this case may be used for vehicle allocation control or the like for achieving efficient taxi allocation to each area, for example.

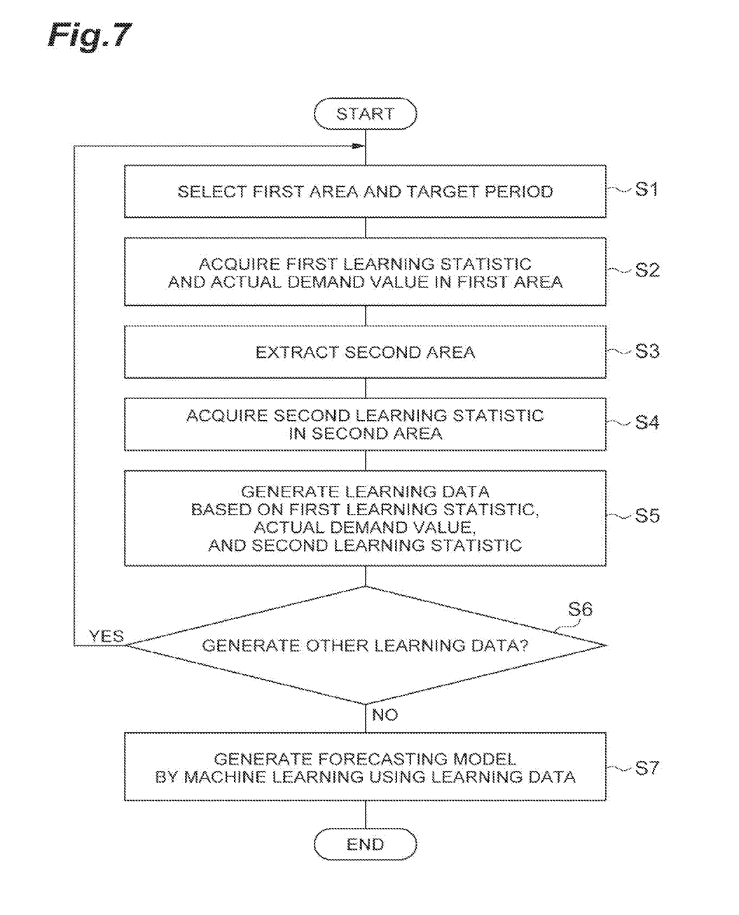

The procedure of the processing in the model generation unit 12 will be described with reference to the flow chart shown in FIG. 7.

In Step S1, the first learning statistic acquisition unit 121 sets a first area and a target period by receiving an input from an operator, for example. For example, an area corresponding to one mesh may be set as the first area. The target period is a period (for example, 6 hours) arbitrarily extracted from the period in which statistical data ST is stored.

In Step S2, the first learning statistic acquisition unit 121 acquires a first learning statistic in the target period in the first area A1. Further, the first learning statistic acquisition unit 121 acquires the actual demand value (the number of times of pickup) in the first area A1 associated with a period after the target period (for example, 30 minutes from the end point of the target period).

In Step S3, the second area extraction unit 122 extracts at least one second area A2 that is different in size from the first area A1 and surrounds the first area A1. The second area extraction unit 122 extracts the second area A2, for example, using any of the methods of the first to fourth extraction examples.

In Step S4, the second learning statistic acquisition unit 123 acquires a second learning statistic in the second area A2. The second learning statistic acquisition unit 123 determines the second learning statistic acquisition target period (the same target period as the target period corresponding to the first learning statistic acquisition target period or a period before the target period) using, for example, any one of the methods of the first to fourth acquisition examples described above.

In Step S5, the model generation unit 12 generates a set of learning data (data including a first learning statistic used as an explanatory variable and the actual demand value in the first area A1 used as the second learning statistic and a target variable) based on the first learning statistic, the actual demand value, and the second learning statistic.

In Step S6, the model generation unit 12 determines whether other learning data should be generated. For example, the model generation unit 12 may repeat learning data generation processing (Steps S1 to S5) (Step S6: NO) until it is determined that an appropriate number (for example, a number preset by the operator) of pieces of learning data for generating a forecasting model have been obtained. Meanwhile, when it is determined that an appropriate number of pieces of learning data have successfully been obtained (Step S6: YES), the model generating unit 12 proceeds to the processing in Step S7.

In Step S7, the generation unit 124 generates a forecasting model by executing machine learning using learning data generated in Step S5. The generated forecasting model is stored in the storage unit 11, for example.

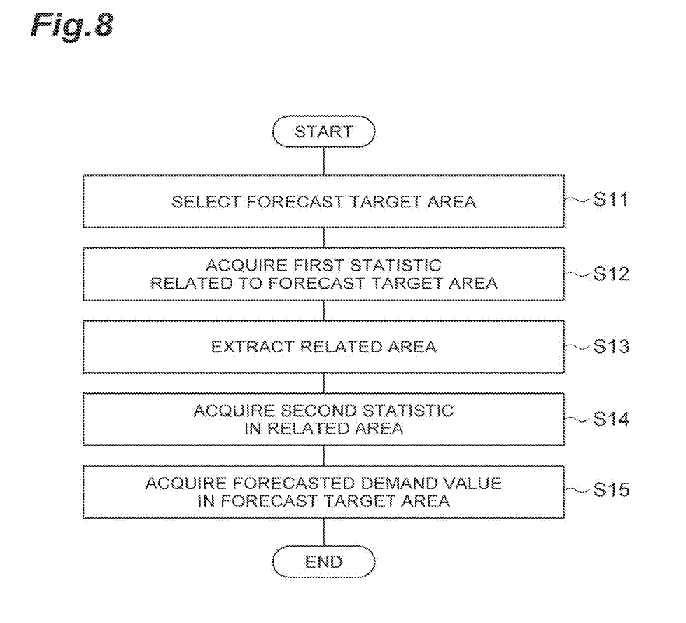

The procedure of the processing for actually forecasting the forecasted demand value in a forecast target area will now be explained with reference to the flow chart shown in FIG. 8.

In Step, S11, the first statistic acquisition unit 13 selects a forecast target area serving as a demand forecast target, by receiving an input from the operator, for example.

In Step S12, the first statistic acquisition unit 13 acquires the first statistic representing a feature associated with a past period (six hours immediately before the current point in time) in relation to the forecast target area. To be specific, the first statistic acquisition unit 13 acquires the first statistic related to the forecast target area by performing the same processing as that for acquiring the first learning statistic related to the first area A1 (the processing in the first learning statistic acquisition unit 121).

In Step S13, the area extraction unit 14 extracts at least one related area which is different in size from the forecast target area and surrounds the forecast target area. To be specific, the area extraction unit 14 acquires the related area associated with the forecast target area by performing the same processing as that for extracting the second area A2 with respect to the first area A1 (the processing in the second area extraction unit 122).

In Step S14, the second statistic acquisition unit 15 acquires a second statistic in the related area. To be specific, the second statistic acquisition unit 15 acquires the second statistic associated with the related area by performing the same processing as that for acquiring the second learning statistic related to the second area (the processing in the second learning statistic acquisition unit 123).

In Step S15, the demand forecast unit 16 inputs the first statistic and the second statistic to a forecasting model prepared in advance (a forecasting model generated by the model generation unit 12), thereby acquiring the forecasted demand value in the forecast target area.

The server 10 described above calculates the forecasted demand value in the forecast target area, based on not only the statistic (the first statistic) related to the forecast target area but also the statistic (the second statistic) related to the related area that is different in size from the forecast target area and surrounds the forecast target area. The second statistic related to such a related area can possibly be data useful for improving the accuracy of the demand forecast for the forecast target area, regardless of which area is selected as the forecast target area. Accordingly, the server 10 can suppress variations in forecast accuracy among a plurality of areas in the case where a forecasting model common to the areas is used. As a result, the accuracy of demand forecast for each forecast target area, and services (in this embodiment, proper allocation of taxis) can be smoothly provided in each forecast target area.

A forecast target area may be a region corresponding to one of meshes each preset as a geographical section, and a related area may be a region consisting of a plurality of meshes. For example, the forecast target area and the related area may be set similarly to the first area A1 and the second area A2 in the first or second extraction example. Since a region into which a plurality of meshes around a forecast target area are collected is set as a related area, the above-described effects are provided and the number of explanatory variables (the second statistic) can be reduced from that in the case where each mesh is separately treated.

The area extraction unit 14 may extract a related area based on the distance from the forecast target area. For example, the area extraction unit 14 may extract a related area by the same processing as that performed in any one of the first to third extraction examples described above. In this case, a related area can be set based on the degree of influence on the future demand in the forecast target area (that is, the shorter the distance, the higher the degree of influence).

The area extraction unit 14 may extract a related area based on the travel time to/from the forecast target area. For example, the area extraction unit 14 may extract a related area by the same processing as that performed in the fourth extraction example described above. In this case, a related area can be set based on the degree of influence on the future demand in the forecast target area (that is, the shorter the travel time, the higher the degree of influence).

The second statistic acquisition unit 15 acquires, as the second statistic, a statistic that is related to a period having a predetermined time difference from a past period, and includes information about the staying population in the related area. The second statistic acquisition unit 15 may determine the predetermined time difference based on the travel time between the forecast target area and the related area. For example, the predetermined time difference may be determined by the same processing as that performed in the second acquisition example described above. Since the second statistic acquisition target period is shifted behind the first statistic acquisition target period considering the time that elapses before the time that the staying population in the related area affects the taxi demand in the forecast target area in this manner, more meaningful (useful) data can be used as an explanatory variable.

The second statistic acquisition unit 15 may determine the predetermined time difference based on the relationship between the actual demand value in the forecast target area and the staying population in the related area. For example, the predetermined time difference may be determined by the same processing as that performed in the third acquisition example described above. Since a time difference is determined based on a relationship between the actual demand value in the forecast target area and the staying population in the related area (in this embodiment, a correlation between the actual demand value and the population difference) in the above-described manner, more meaningful (useful) data can be used as an explanatory variable.

The server 10 includes the model generation unit 12. For at least one first area A1, the model generation unit 12 includes a first learning statistic acquisition unit 121 that acquires a first learning statistic representing a feature of the first area A1 associated with a predetermined target period, and the actual demand value in the first area A1 associated with a period after the target period; the second area extraction unit 122 that extracts at least one second area A2 that is different in size from the first area A1 and surrounds the first area A1; the second learning statistic acquisition unit 123 that acquires the second learning statistic representing a feature of the second area A2; and the generation unit 124 that generates a forecasting model by executing machine learning using learning data in which the first learning statistic and the second learning statistic are associated with the actual demand value in the first area A1. Such a model generation unit 12 can generate a forecasting model in which variations in forecast accuracy among areas can be suppressed.

It should be noted that the present invention should not be limited to the above-described embodiment. For example, explanatory variables in a forecasting model may include a feature amount other than the statistics illustrated above. For example, a feature amount independent of a period such as the number of facilities (for example, stations) included in the area may be added to the explanatory variables. Further, a feature amount based on periodically repeated time relevance, such as the average demand in the same day of the week and same time period (the average of the number of times of taxi pickup) may be added to explanatory variables. Although the number of taxi passengers is a forecast target in the above embodiment, the demand to be a forecast target is not limited to this, and the present invention is applicable to the forecast of the demand of various services. For example, the present invention is also applicable to the forecast of the sales of products (the target variable is the number of sales or amount of money) and the like.

It should be noted that the block diagrams used for the description of the embodiment above indicate function unit blocks. These functional blocks (constituent parts) are implemented with an arbitrary hardware and/or software combination. There is no limitation on the means for implementing each functional block. In other words, each functional block may be implemented by one physically and/or logically combined device, or by two or more devices physically and/or logically separated and directly and/or indirectly connected (for example, by wire and/or wirelessly).

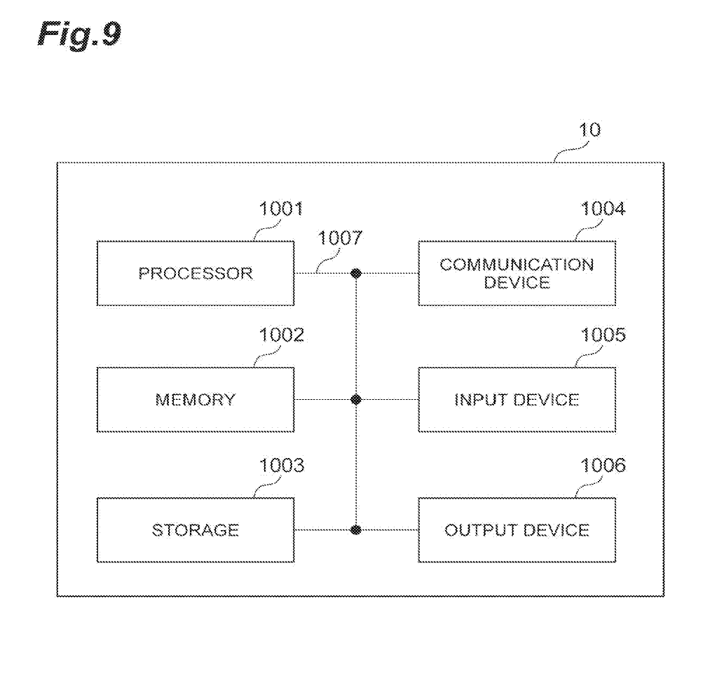

For example, the server 10 of the above-described embodiment may function as a computer that performs processing for the server 10 of the above-described embodiment. FIG. 9 is a diagram showing an example of the hardware configuration of the server 10 according to this embodiment. The server 10 described above may be physically configured as a computer device including a processor 1001, a memory 1002, a storage 1003, a communication device 1004, an input device 1005, an output device 1006, and a bus 1007.

In the following description, the term “device” may be replaced with circuit, device, unit, or the like. The hardware configuration of the server 10 may include one or more of each device shown in FIG. 9, or may be made without some of these devices.

Each function of the server 10 is implemented when a predetermined hardware, such as the processor 1001 or the memory 1002, is made read a predetermined software (program) so that the processor 1001 performs operation to control communication through the communication device 1004 and reading and/or writing of data from/to the memory 1002 and the storage 1003.

The processor 1001 operates an operating system to control the overall computer, for example. The processor 1001 may be a central processing unit (CPU) including an interface through which to connect to a peripheral device, a control device, an arithmetic device, and a register.

In addition, the processor 1001 reads a program (program code), a software module, and/or data from the storage 1003 and/or the communication device 1004 into the memory 1002, and executes various types of processing according to these. This program is a program for causing a computer to execute at least part of the behavior described in the embodiment above. For example, the demand forecast unit 16 of the server 10 may be implemented with a control program stored in the memory 1002 and operating on the processor 1001, and the other functional blocks shown in FIG. 1 may be implemented in a similar manner. Although the above-described various types of processing are executed by one processor 1001 according to the above description, these may be executed simultaneously or sequentially by two or more processors 1001. The processor 1001 may be implemented with one or more chips. It should be noted that the program may be transmitted from a network via a telecommunication line.

The memory 1002 is a computer readable recording medium and may be at least one recording medium selected from the group consisting of read only memory (ROM), erasable programmable ROM (EPROM), electrically erasable programmable ROM (EEPROM), and random access memory (RAM). The memory 1002 may be referred to as a register, a cache, a main memory, or the like. The memory 1002 can store programs (program codes), software modules, and the like executable for implementing the information processing method (the procedure shown in the flow chart of FIG. 7 or 8) according to the above-described embodiment.

The storage 1003 is a computer readable recording medium and may be at least one recording medium selected from the group consisting of an optical disk, such as a compact disc ROM (CD-ROM), a hard disk drive, a flexible disk, a magneto-optical disk (for example, a compact disk, a digital versatile disk, or a Blu-ray (registered trademark) disk), a smart card, a flash memory (for example, a card, a stick, or a key drive), a floppy (registered trademark) disk, and a magnetic strip. The storage 1003 may be referred to as an auxiliary storage device. The above-described storage medium may be, for example, a database, a server, or other suitable media including the memory 1002 and/or the storage 1003.

The communication device 1004 is a hardware (transmission/reception device) for establishing communication between computers via a wired and/or wireless network, and is also referred to as a network device, a network controller, a network card, a communication module, or the like.

The input device 1005 is an input device (for example, a keyboard, a mouse, a microphone, a switch, a button, or a sensor) that receives inputs from external devices. The output device 1006 is an output device (for example, a display, a speaker, or an LED lamp) that gives outputs to external devices. Note that the input device 1005 and the output device 1006 may be integrated into one device (for example, a touch panel).

In addition, the devices such as the processor 1001 and the memory 1002 are connected via the bus 1007 for information communication. The bus 1007 may be composed of a single bus or may differ between the devices.

Further, the server 10 may include a hardware device, such as a microprocessor, a digital signal processor (DSP), an application specific integrated circuit (ASIC), a programmable logic device (PLD), or a field programmable gate array (FPGA), and some or all of the functional blocks may be implemented by the hardware device. For example, the processor 1001 may be implemented using at least one of these hardware.

Although the present invention has been described in detail above, it will be obvious to those skilled in the art that the present invention should not be limited to the embodiments described in this specification. The present invention can be implemented as a modified and altered mode without departing from the spirit and scope of the present invention defined by the scope of the claims. Therefore, the description of this specification is aimed at illustration and does not have any restrictive meaning in relation to the present invention.

As long as there is no inconsistency, the processing order, the order of flow chart steps, and the like in each mode/embodiment described in this specification may be changed. For example, regarding the methods described in this specification, elements of various steps are presented in an exemplary order and the presented specific order is not necessarily the case.

Input/output information and the like may be stored in a specific place (for example, a memory) or managed with a management table. Input/output information and the like can be overwritten, updated, or additionally written. Output information and the like may be deleted. Input information and the like may be transmitted to another device.

The determination may be performed using a one-bit value (0 or 1) or a Boolean (true or false), or by comparison between numerical values (for example, comparison with a predetermined value).

The modes/embodiments described in this specification may be used alone or in combination, or switching between them may be performed upon their execution. In addition, notification of predetermined information (for example, notification of “being X”) is not necessarily explicit but may be implicit (for example, in such a manner that the predetermined information is not notified).

A software should be widely interpreted as an instruction, an instruction set, a code, a code segment, a program code, a program, a subprogram, a software module, an application, a software application, a software package, a routine, a subroutine, an object, an executable file, an execution thread, a procedure, a function, or the like, regardless of whether it is called software, firmware, middleware, microcode, hardware description language, or other names.

In addition, software, instructions, and the like may be transmitted and received via a transmission medium. For example, when the software is transmitted from a website, a server, or other remote sources using wired technology, such as a coaxial cable, fiber optic cable, twisted pair, or digital subscriber line (DSL), and/or wireless technology, such as infrared, wireless, or microwave technology, these wired and/or wireless technologies are included within the definition of the transmission medium.

The information, signals, and the like described in this specification may be represented using any of a variety of different technologies. For example, data, instructions, commands, information, signals, bits, symbols, chips, and the like that may be mentioned throughout the above description may be represented by voltage, current, electromagnetic waves, magnetic fields or particles, optical fields or photons, or an arbitrary combination thereof.

It should be noted that the terms described in this specification and/or terms necessary for understanding this specification may be replaced by terms having the same or similar meanings.

The terms “system” and “network” used in this specification are used interchangeably.

In addition, the information, parameters, and the like described in the present specification may be represented by absolute values, values relative to predetermined values, or may be represented by other corresponding information.

The names used for the above parameters are not restrictive in any way. In addition, mathematical expressions and the like using these parameters may be different from those explicitly disclosed in this specification.

The term “determining” used in this specification may include a wide variety of operations. “Determining” may include “determining” the acts of, for example, calculating, computing, processing, deriving, investigating, looking up (for example, looking up a table, database or other data structures), and ascertaining. Further, “determining” may also include “determining” the acts of “receiving” (for example, receiving information), transmitting (for example, transmitting information), input, output, and accessing (for example, accessing data in the memory). Further, “determining” may also include “determining” the acts of resolving, selecting, choosing, establishing, comparing and the like. In other words, “determining” may include “determining” some action.

The phrase “based on” used in this specification does not mean “based only on” unless otherwise explicitly stated. In other words, the phrase “based on” means both “based only on” and “based on at least”.

No reference to elements using the designation “first”, “second”, and the like used in this specification generally does not limit the amount or order of these elements. These designations can be used in this specification as a convenient way of distinguishing two or more elements. Therefore, reference to the first and second elements does not mean that only two elements may be adopted there, or that the first element must precede the second element in some way.

As long as “include”, “including”, and variations thereof, and variations thereof are used in this specification or claims, the terms are intended to be inclusive similarly to the term “comprising”. In addition, the term “or” used in this specification or claims is intended to be not exclusive or.

In this specification, a device is supposed to include a plurality of devices unless the device is clearly shown as being only one in the context or technically.

Throughout this disclosure, an element is supposed to include a plurality of elements unless it is clearly shown as being singular in the context.

### REFERENCE SIGNS LIST

10 . . . Server, 11 . . . Storage unit, 12 . . . Model generation unit, 13 . . . First statistic acquisition unit, 14 . . . Area extraction unit, 15 . . . Second statistic acquisition unit, 16 . . . Demand forecast unit, 121 . . . First learning statistic acquisition unit, 122 . . . Second area extraction unit, 123 . . . Second learning statistic acquisition unit, 124 . . . Generation unit, 1001 . . . Processor, 1002 . . . Memory, 1003 . . . Storage, 1004 . . . Communication device, 1005 . . . Input device, 1006 . . . Output device

1. A demand forecast device comprising:
a first statistic acquisition unit acquiring a first statistic representing a feature associated with a past period related to a forecast target area serving as a target for forecast of a demand of a predetermined service;
an area extraction unit extracting at least one related area that is different in size from the forecast target area and surrounds the forecast target area;
a second statistic acquisition unit acquiring a second statistic representing a feature of the related area; and
a demand forecast unit inputting the first statistic and the second statistic to a forecasting model prepared in advance, thereby acquiring a forecasted demand value in the forecast target area.

2. The demand forecast device according to claim 1, wherein
the forecast target area is a region corresponding to one of meshes each preset as a geographical section, and
the related area is a region consisting of a plurality of the meshes.

3. The demand forecast device according to claim 1, wherein the area extraction unit extracts the related area based on a distance from the forecast target area.

4. The demand forecast device according to claim 1, wherein the area extraction unit extracts the related area based on travel time to/from the forecast target area.

5. The demand forecast device according to claim 1, wherein the second statistic acquisition unit acquires, as the second statistic, a statistic that is related to a period having a predetermined time difference from the past period and includes information about a staying population in the related area.

6. The demand forecast device according to claim 5, wherein the second statistic acquisition unit determines the predetermined time difference based on travel time between the forecast target area and the related area.

7. The demand forecast device according to claim 5, wherein the second statistic acquisition unit determines the predetermined time difference based on a relationship between an actual demand value in the forecast target area and the staying population.

8. The demand forecast device according to claim 1, further comprising a model generation unit generating the forecasting model, the model generation unit comprising:
a first learning statistic acquisition unit acquiring, for at least one first area, a first learning statistic that represents a feature of the first area associated with a predetermined target period, and an actual demand value in the first area associated with a period after the target period;
a second area extraction unit extracting at least one second area that is different in size from the first area and surrounds the first area;
a second learning statistic acquisition unit acquiring a second learning statistic representing a feature of the second area; and
a generation unit generating the forecasting model by executing machine learning using learning data that is data in which the first learning statistic and the second learning statistic are associated with the actual demand value in the first area.

9. The demand forecast device according to claim 2, wherein the area extraction unit extracts the related area based on a distance from the forecast target area.

10. The demand forecast device according to claim 2, wherein the area extraction unit extracts the related area based on travel time to/from the forecast target area.
